(19) United States
(12) Patent Application Publication
(10) Pub. No.: US 2021/0276102 A1
(43) Pub. Date: Sep. 9, 2021

(54) METHOD OF MACHINING TI, TI-ALLOYS AND NI-BASED ALLOYS

(71) Applicant: SANDVIK INTELLECTUAL PROPERTY AB, Sandviken (SE)

(72) Inventors: Ibrahim SADIK, Kista (SE); Jose Luis GARCIA, Stockholm (SE)

(21) Appl. No.: 16/347,563

(22) PCT Filed: Nov. 6, 2017
(86) PCT No.: PCT/EP2017/078321

§ 371 Date: May 3, 2019

(30) Foreign Application Priority Data
Nov. 8, 2016 (EP) 16197650.1

(51) Int. Cl. B23B 27/14; B23B 1/00; B23C 5/16; B23Q 11/10

(52) U.S. Cl. CPC B23B 27/14; B23B 1/00; B23C 2250/12; B23Q 11/1053; B23B 2224/00; B23C 5/16

(57) ABSTRACT

A cemented carbide cutting tool having WC and a low amount of binder phase can be used when machining Ti, Ti-alloys and Ni-based alloys under cryogenic conditions, leading to a significantly prolonged tool life.

The present invention relates to the use of a cemented carbide cutting tool comprising WC and a low amount of binder phase when machining Ti, Ti-alloys and Ni-based alloys under cryogenic conditions.

### BACKGROUND

Cutting tools made of cemented carbide are well known in the art for machining Ti-alloys and Ni-alloys like Inconel. These materials are known to be difficult to machine. One of the problems that can occur when machining these types of work piece materials is chemical wear.

Chemical wear is common for machining Ti-alloys. Therefore, the solubility and reactivity with the work piece material is found to be very important when selecting an insert for machining Ti-alloys. The extremely low thermal conductivity of Ti causes heat transfer to the insert and enhanced chemical reactivity.

It is also well known in the art of machining that it is beneficial to use some type of cooling in order to keep the temperature down.

In many applications a coolant is used to achieve this. However, the conventional coolants are not always environmentally friendly and needs to be processed. Recycling of the coolant is difficult since it will contain chips from the work piece material. Larger chips can of course be removed but the smaller ones in the range of a few micrometers will remain. These small fragments can cause damage to the work piece material if the coolant is reused.

Also, the use of conventional coolants such as emulsions or MQL (minimum quantity lubrication) can, in some aerospace applications, limit the possibility to recycle the chips. For example, in some aerospace applications, recycled chips cannot be used when producing new alloys due to contamination with coolant emulsions or lubricants.

For some applications, the cooling effect that is achieved by the conventional coolants (emulsions) is not enough. Cryogenic machining is one alternative to achieve a more efficient cooling effect. Cryogenic cooling is also a good alternative to traditional coolants for environmental reasons since they are non-toxic.

One object of the present invention is to improve tool life when machining Ti, Ti-alloys and Ni-based alloys.

### DETAILED DESCRIPTION OF THE INVENTION

The present invention relates to the use of a cutting tool comprising a cemented carbide substrate comprising WC and a binder phase content of between 1 and 5 wt %, and with an average WC grain size of between 1.2 and 8 μm. The cutting tool is used for machining in Ti, Ti-alloys or Ni-based alloys together with a cryogenic coolant.

The definition of cryogenic has somewhat varied over the years. The scientific definition is that the temperature should be below −153° C. However, in recent years the definition has somewhat broaden and in more recent publications e.g. CO₂ is also included which has a temperature of −80° C.

By cryogenic cooling is herein meant that the coolant ha a temperature below −50° C. Suitably the coolant is liquid nitrogen and/or CO₂.

In one embodiment of the present invention the coolant is liquid nitrogen.

In another embodiment of the present invention the coolant is liquid CO₂. The CO₂ can either be in the form of a liquid (supercritical), a gas or a mix of liquid/gas.

In one embodiment of the present invention, the cryogenic coolant is combined with MQL (minimum quantity lubrication).

In another embodiment of the present invention the cryogenic coolant is combined with compressed air. This is beneficial sometimes to help remove the chips from the cutting area.

In another embodiment of the present invention the cryogenic coolant is combined with both compressed air and MQL (minimum quantity lubrication).

The flow of the coolant depends on the exact application and setup but is suitably between 0.05 to 1 kg/min. The pressure of the coolant will also vary depending on the exact application and setup but is suitably between 3 to 100 Bar.

The coolant can be applied in different ways depending on the type of machining operation and tool type etc.

In one embodiment of the present invention, the coolant is provided by external cooling. By that is meant that the coolant is provided by one or more separate nozzles directed towards the area where the machining takes place, i.e. where the tool and the workpiece material meet.

In one embodiment of the present invention, the coolant is provided by internal cooling through the tool holder. By that is meant that the coolant is provided by channels in the tool holder that will apply the coolant directly onto the cutting tool.

In one embodiment of the present invention, the coolant is provided by internal cooling through the tool holder and the cutting tool, i.e. a closed loop. By that is meant that the coolant is provided through channels which will lead the coolant through the tool holder and through the cutting tool and then back again through the tool holder in a closed loop. The coolant can thus be reused.

In one embodiment of the present invention, the coolant is provided by internal cooling through the tool holder and the cutting tool and where the coolant is leaving the cutting tool, i.e. there is no closed loop. This embodiment is common for e.g. drills.

In one embodiment of the present invention, the coolant can be provided by a combination of at least two types of cooling methods as disclosed above, i.e. selected from external cooling, internal cooling through the tool holder and internal cooling through the tool holder and through the cutting tool with or without closed loop.

In one embodiment of the present invention, the method of machining is suitably a turning operation. Suitably the machining parameters are V_{c} between 30 and 200 m/min, preferably between 30 and 120 m/min, more preferably between 100 to 120 m/min, aₚ between 0.1 and 5 mm, preferably between 0.3 and 2 mm. The feed rate, f_{z}, is suitably between 0.05 and 0.4 mm/rev, preferably between 0.05 and 0.3 mm/rev.

The cutting tool comprising a substrate of cemented carbide according to the present invention is suitable for machining non-ferrous alloys, most suitable for Ti or Ti-alloys and/or Ni-based alloys and most suitable for Ti or Ti-alloys. Examples of Ti and Ti alloys are suitably α, β and γ alloys, e.g. α-Ti and α-alloys such as Ti₅Al_{2.5}Sn, near α-alloys such as Ti₆Al₂Sn₄Zr₂Mo, α+β alloys such as Ti₆Al₂Sn₄Zr₆Mo and Ti₆Al₄V. Examples of Ni-based alloys are Inconel 718, Waspaloy and Haynes 282 alloy.

The cutting tool comprises a cemented carbide comprising WC and a binder phase where the binder phase content is between 1 and 5 wt % and the average WC grain size is suitably between 1.2 and 8 μm.

The WC in the cemented carbide according to the present invention suitably has an average grain size of between 1.2 to 8 μm, preferably between 2 to 5 μm more preferably between 3 to 4 μm. The WC grain size is preferably measured by using line intercept method on Scanning Electron Microscope Images. In production etc. an estimation of the grain size can be made from Coercivity measurements.

In addition to WC and a binder phase, the cemented carbide can also comprise other constituents common in the art of making cemented carbides e.g. Nb, Ta, Ti and Cr. The amount of these elements may vary between 20 ppm by weight and 5 wt % of the total cemented carbide.

In one embodiment of the present invention, the amount of additional constituents, i.e. in addition to WC, is between 20 ppm by weight and 1 wt %, preferably between 20 and 250 ppm by weight of the total cemented carbide.

In another embodiment of the present invention, WC is the only hard constituent present.

The cemented carbide can also comprise small amounts of other elements common in the art, such as rare earths, oxides, aluminides and borides.

The binder phase content in the cutting tool comprising a substrate of cemented carbide is suitably between 1 to 5 wt %, preferably between 2 to 4 wt %.

The binder phase can comprise one or more of Co, Ni and Fe.

In one embodiment of the present invention, the binder phase mainly comprises Co. By that is herein meant that, as raw material for the binder phase, only Co is added. However, during manufacturing other elements might dissolve partly in the Co.

The cemented carbide is suitably free from eta phase and free graphite. Preferably, the cemented carbide has a slightly overstoichiometric carbon content.

In one embodiment of the present invention, the cemented carbide consists of WC and Co and unavoidable impurities.

It is common in the art to provide cemented carbide tools with a coating in order to increase the tool life. The cemented carbide according to the present invention can either be uncoated or be provided with a coating, suitably a CVD or PVD coating known in the art.

In one embodiment of the present invention, a cutting tool according to the present invention is suitably uncoated.

In one embodiment of the present invention, the cemented carbide body is provided with a coating useful for wear detection, e.g. TiN with a thickness of 0.2-3 μm.

In another embodiment of the present invention, the cemented carbide body is provided with a coating comprising carbon, e.g. a DLC coating with a thickness of 0.2-3 μm, deposited by e.g. CVD.

In another embodiment of the present invention, the cemented carbide body is provided with a coating comprising diamond with a thickness of between 0.5 to 15 μm.

In another embodiment of the present invention, the cemented carbide body is provided with a coating comprising a ZrC monolayer with a thickness of 0.2-3 μm by CVD deposition.

By cutting tool is herein meant an insert, drill or an end mill.

In one embodiment of the present invention, the cutting tool is a turning insert.

Further, the present invention also relates to a method of machining Ti, Ti alloys or Ni-based alloys by the use of a cutting tool, as has been described above, comprising a cemented carbide substrate comprising WC and a binder phase content of between 1 and 5 wt %, and with an average WC grain size of between 1.2 and 8 μm, and the use of a cryogenic coolant.

### EXAMPLE 1

### Invention

A mixture made of WC with an average grain size and 3 wt % Co was mixed and blended for 18 h, pressed and sintered at 1410° C. for 1 h under vacuum conditions. After sintering the cemented carbide consists of WC embedded in Co metal binder phase. The sintered piece was then subjected to a second sintering step at 1410° C. for 1. h.

The resulting cemented carbide had a WC grain size of 3.4 μm as calculated from the Coercivity, 16.5 kA/m, which has been measured using a Foerster Koerzimat CS1.096 according to DIN ISO 3326.

This cemented carbide body is called Sample 1.

### EXAMPLE 2

### Reference

A mixture made of WC, 6 wt % Co with additional extra carbon was mixed and blended for 18 h, pressed and sintered at 1410° C. for 1 h under vacuum conditions. After sintering the cemented carbide comprised WC embedded in a Co metal binder phase. The Coercivity was 18 kA/m, measured using a Foerster Koerzimat CS1.096 according to DIN ISO 3326.

The WC average grain size was 0.76 μm measured using the line intercept method.

This cemented carbide body is called Sample 2.

### EXAMPLE 3

### Working Example

The inserts described in example 1 and 2 were tested in a turning operation in a Ti₆Al₄V alloy using the following conditions:
ap=2 mm
F_{z}=0.1-0.2 mm/rev, Variable
Vc=70 m/min
Cooling: Liquid nitrogen, 7 bar, 0.85 kg/min, internal through the holder
   The tool life criterion was flank wear (VB=0.3 mm), notch (VBₙ=0.4 mm) or edge destruction. The results can be seen in Table 1 where each result is an average of two tests, i.e. of two inserts.

TABLE 1

| Cutting tool | Feed rate (mm/rev) | Tool life (minutes) |
|---|---|---|
| Sample 1 (Invention) | 0.1 | 47 |
| Sample 2 (Comparative) | 0.1 | 20 |
| Sample 1 (Invention) | 0.15 | 22 |
| Sample 2 (Comparative) | 0.15 | 6 |
| Sample 1 (Invention) | 0.2 | 16 |
| Sample 2 (Comparative) | 0.2 | 3 |

### EXAMPLE 4

### Working Example

The inserts described in example 1 and 2 were tested in a turning operation in a Ti₆Al₄V alloy using the following conditions:
ap=2 mm
F_{z}=0.1-0.2 mm/rev, Variable
Vc=115 m/min
Cooling: Liquid nitrogen, 7 bar, 0.85 kg/min, internal through the holder
   The tool life criterion was flank wear (VB=0.3 mm), notch (VBₙ=0.4 mm) or edge destruction. The results can be seen in Table 2 where each result is an average of two tests, i.e. of two inserts.

TABLE 2

| Cutting tool | Feed rate (mm/rev) | Tool life (minutes) |
|---|---|---|
| Sample 1 (Invention) | 0.1 | 4.5 |
| Sample 2 (Comparative) | 0.1 | 1 |
| Sample 1 (Invention) | 0.15 | 4 |
| Sample 2 (Comparative) | 0.15 | 0.5 |
| Sample 1 (Invention) | 0.2 | 2 |
| Sample 2 (Comparative) | 0.2 | 0.3 |

1. A method of using of a cutting tool comprising:
providing a cutting tool of a cemented carbide substrate comprising WC and a binder phase content of between 1 and 5 wt %, and with an average WC grain size of between 1.2 and 8 μm; and
machining in Ti, Ti-alloys or Ni-based alloys wherein a cryogenic coolant is used.

2. The method of using a cutting tool according to claim 1, wherein the coolant is liquid nitrogen.

3. The method of using a cutting tool according to claim 1, wherein the coolant is liquid CO₂.

4. The method of using a cutting tool according to claim 1, wherein the turning operation is operated at a V_{c} of between 30 to 200 m/min, at an aₚ between 0.1 to 5 mm and at a feed rate of between 0.05 to 0.4 mm/rev.

5. The method of using a cutting tool according to claim 1, wherein the coolant is provided through external cooling.

6. The method of using a cutting tool according to claim 1, wherein the coolant is provided through internal cooling through a tool holder.

7. The method of using a cutting tool according to claim 1, wherein the coolant is provided through internal cooling through a tool holder and the cutting tool.

8. The method of using a cutting tool according to claim 1, wherein the average grain size of the WC in the cemented carbide is between 2 and 5 μm.

9. The method of using a cutting tool according to claim 1, wherein the binder phase is cobalt in an amount of between 2 and 4 wt %.

10. The method of using a cutting tool according to claim 1, wherein the cutting tool is uncoated.

11. The method of using a cutting tool according to claim 1, wherein the cutting tool is provided with a coating.

12. A method of machining TI, Ti-alloys and Ni-based alloys comprising:
using a cutting tool of a cemented carbide substrate comprising WC and a binder phase content of between 1 and 5 wt %, and with an average WC grain size of between 1.2 and 8 μm; and
cooling with a cryogenic coolant.
